(19) United States
(12) Patent Application Publication
(10) Pub. No.: US 2026/0246225 A1
(43) Pub. Date: Aug. 20, 2026

(54) RAMAN-BOOSTED PULSE-PUMPED OPTICAL AMPLIFIERS

(71) Applicant: Raytheon Company, Arlington, VA (US)

(72) Inventor: Fabio Di Teodoro, Hacienda Heights, CA (US)

(21) Appl. No.: 19/056,545

(22) Filed: Feb. 18, 2025

(51) Int. Cl. H01S 3/23; H01S 3/067; H01S 3/094; H01S 3/10; H01S 3/108; H01S 3/16; H01S 3/30

(52) U.S. Cl. CPC H01S 3/2316; H01S 3/06716; H01S 3/06733; H01S 3/094053; H01S 3/094076; H01S 3/10007; H01S 3/108; H01S 3/161; H01S 3/1616; H01S 3/302

(57) ABSTRACT

A system includes a pulsed pump laser configured to provide a pulsed pump laser beam at a first wavelength and having a first power level associated therewith, a pulsed seed laser configured to provide a pulsed seed laser beam at a second wavelength and having a second power level associated therewith, at least one diode laser configured to provide at least one diode laser beam having a third wavelength less than the first wavelength, an optical combiner configured to combine the pulsed pump laser beam, the pulsed seed laser beam, and the at least one diode laser beam onto a single optical fiber as a combined signal. The system also includes an optical amplifier configured to linearly amplify the combined signal at the first wavelength to generate an amplified combined signal and non-linearly amplify the amplified combined signal at the second wavelength.

### TECHNICAL FIELD

This disclosure relates generally to optical amplifiers. More specifically, this disclosure relates to Raman-boosted pulse-pumped short-wave infrared (SWIR) or other optical amplifiers.

### BACKGROUND

Laser transmitters are used in a number of remote sensing applications, such as light detection and ranging (LiDAR). Laser light is often directed onto a target, and reflected laser light is detected returning from the target. These types of systems often require good transmission characteristics through the atmosphere and certain window materials. One type of laser that is particularly effective in transmission through the atmosphere is 2.1 μm wavelength lasers. These lasers have significantly better transmission characteristics through the atmosphere than other types of lasers at different wavelengths. However, producible 2.1 μm lasers are nearly nonexistent. Most commercial off-the-shelf lasers in the 2.1 μm range are plagued by various inefficiencies.

### SUMMARY

This disclosure relates to Raman-boosted pulse-pumped short-wave infrared (SWIR) or other optical amplifiers.

In some examples, a system includes a pulsed pump laser configured to provide a pulsed pump laser beam at a first wavelength and having a first power level associated therewith, a pulsed seed laser configured to provide a pulsed seed laser beam at a second wavelength and having a second power level associated therewith, at least one diode laser configured to provide at least one diode laser beam having a third wavelength less than the first wavelength, an optical combiner configured to combine the pulsed pump laser beam, the pulsed seed laser beam, and the at least one diode laser beam onto a single optical fiber as a combined signal. The system also includes an optical amplifier configured to linearly amplify the combined signal at the first wavelength to generate an amplified combined signal and non-linearly amplify the amplified combined signal at the second wavelength.

Any single one or any combination of the following features may be used with the examples above. The system where the optical combiner may include a multiplexer configured to multiplex the pulsed pump laser beam and the pulsed seed laser beam to generate a first combined signal and a pump/signal combiner configured to combine the first combined signal with the at least one diode laser beam to generate a second combined signal. The first amplifier may include a double-clad thulium-doped fiber configured to amplify the combined signal at the first wavelength responsive to the combined signal at the third wavelength. The second amplifier may include a single-clad holmium-doped fiber configured to amplify the amplified combined signal at the second wavelength responsive to the amplified combined signal at the first wavelength and to provide Raman amplification. The first wavelength is approximately 1.9 m the second wavelength is approximately 2.1 m and the third wavelength is approximately 793 nm. A first pulse width of the pulsed pump laser beam is configured to overlap an entire second pulse width of the pulsed seed laser beam to provide non-linear amplification in the second amplifier. A first pulse width of the pulsed pump laser beam is configured to be wider than a second pulse width of the pulsed seed laser beam such that a portion of the first pulse width exceeds the second pulse width to increase linear amplification within the first amplifier. A magnitude of at least a portion of a first pulse width of the pulsed pump laser beam is increased to increase non-linear application within the second amplifier. The first and second wavelengths are separated by a spectral interval corresponding to a Raman shift within the second amplifier. The second wavelength greater than the first wavelength, the second power level less than the first power level and where the optical amplifier may include a first amplifier configured to linearly amplify the combined signal at the first wavelength based on the combined signal at the third wavelength and a second amplifier configured to non-linearly amplify the amplified combined signal at the second wavelength based on the amplified combined signal at the first wavelength.

In other examples, a method includes generating a pulsed pump laser beam at a first wavelength and having a first power level associated therewith using a pulsed pump laser, generating a pulsed seed laser beam at a second wavelength and having a second power level associated therewith using a pulsed seed laser, generating at least one diode laser beam each having a third wavelength less than the first wavelength using at least one diode laser, combining the pulsed pump laser beam, the pulsed seed laser beam, and the at least one diode laser beam onto a single optical fiber as a combined signal using an optical combiner and linearly amplifying the combined signal at the first wavelength to generate an amplified combined signal and non-linearly amplify the amplified combined signal at the second wavelength using an optical amplifier.

Any single one or any combination of the following features may be used with the examples above. The method where the optical combiner may include a multiplexer that multiplexes the pulsed pump laser beam and the pulsed seed laser beam to generate a first combined signal and a pump/signal combiner that combines the first combined signal with the at least one diode laser beam to generate a second combined signal. The first amplifier may include a double-clad thulium-doped fiber that amplifies the combined signal at the first wavelength responsive to the combined signal at the third wavelength. The second amplifier may include a single-clad holmium-doped fiber that amplifies the amplified combined signal at the second wavelength responsive to the amplified combined signal at the first wavelength and that provides Raman amplification. Colon>the first wavelength is approximately 1.9 m, the second wavelength is approximately 2.1 m and the third wavelength is approximately 793 nm. A first pulse width of the pulsed pump laser beam overlaps an entire second pulse width of the pulsed seed laser beam to provide non-linear amplification in the second amplifier. A first pulse width of the pulsed pump laser beam is wider than a second pulse width of the pulsed seed laser beam such that a portion of the first pulse width exceeds the second pulse width to increase linear amplification within the first amplifier. A magnitude of at least a portion of a first pulse width of the pulsed pump laser beam is increased to increase non-linear application within the second amplifier. The first and second wavelengths are separated by a spectral interval corresponding to a Raman shift within the second amplifier.

In still other examples, a system includes a pulsed pump laser configured to provide a pulsed pump laser beam at an approximately 1.9 m wavelength and having a first power level associated therewith. The system also includes a pulsed seed laser configured to provide a pulsed seed laser beam at an approximately 2.1 m wavelength and having a second power level associated therewith, the second power level less than the first power level. The system also includes at least one diode laser configured to provide at least one diode laser beam each having an approximately 793 nm wavelength. The system also includes an optical combiner configured to combine the pulsed pump laser beam, the pulsed seed laser beam, and the at least one diode laser beam onto a single optical fiber as a combined signal. The system also includes an optical amplifier configured to receive the combined signal. The system also includes a double-clad thulium-doped fiber configured to linearly amplify the combined signal at the approximately 1.9 m wavelength responsive to the combined signal at the approximately 793 nm wavelength in order to generate an amplified combined signal. The system also includes a single-clad holmium-doped fiber configured to non-linearly amplify the amplified combined signal at the approximately 2.1 m wavelength responsive to the amplified combined signal at the approximately 1.9 m wavelength and provide Raman amplification.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example Raman-boosted pulse-pumped amplifier according to this disclosure;

FIG. 2 illustrates a more detailed example of a Raman-boosted pulse-pumped amplifier according to this disclosure;

FIG. 3 illustrates wavelengths provided by an example holmium-doped fiber according to this disclosure;

FIG. 4 illustrates a Raman gain at particular wavelengths within an example holmium-doped fiber according to this disclosure;

FIG. 5 illustrates a first example approach for time-synchronizing pump pulses and signal pulses within the optical amplifier of FIG. 2 according to this disclosure;

FIG. 6 illustrates a second example approach for time-synchronizing pump pulses and signal pulses within the optical amplifier of FIG. 2 according to this disclosure;

FIG. 7 illustrates a third example approach for time-synchronizing pump pulses and signal pulses within the optical amplifier of FIG. 2 according to this disclosure;

FIG. 8 illustrates another example Raman-boosted pulse-pumped amplifier according to this disclosure; and

FIG. 9 illustrates an example method for operating a Raman-boosted pulse-pumped amplifier according to this disclosure.

### DETAILED DESCRIPTION

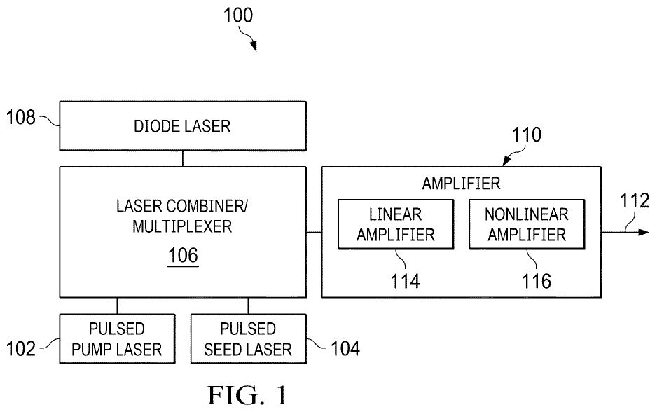

FIGS. 1 through 9, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, laser transmitters are used in a number of remote sensing applications, such as light detection and ranging (LiDAR). Laser light is often directed onto a target, and reflected laser light is detected returning from the target. These types of systems often require good transmission characteristics through the atmosphere and certain window materials. One type of laser that is particularly effective in transmission through the atmosphere is 2.1 μm wavelength lasers. These lasers have significantly better transmission characteristics through the atmosphere than other types of lasers at different wavelengths. However, producible 2.1 μm lasers are nearly nonexistent. Most commercial off-the-shelf lasers in the 2.1 μm range are plagued by various inefficiencies. This disclosure provides various Raman-boosted pulse-pumped short-wave infrared (SWIR) or other optical amplifiers, at least some of which may be used to generate laser illumination in the 2.1 μm range effectively.

FIG. 1 illustrates an example Raman-boosted pulse-pumped amplifier 100 according to this disclosure. As shown in FIG. 1, a pulsed pump laser 102 is configured to generate a pulsed pump laser beam, and a pulsed seed laser 104 is configured to generate a pulsed seed laser beam. The pulsed pump laser beam has a first wavelength and a first power level, and the pulsed seed laser beam has a second wavelength and a second power level. The second wavelength can be greater than the first wavelength, and the second power level can be less than the first power level. The pulsed pump laser beam and the pulsed seed laser beam are provided to a laser combiner/multiplexer 106. At least one diode laser 108 is configured to generate at least one diode laser beam. Each diode laser beam has a third wavelength, and the third wavelength can be less than the first wavelength. The laser combiner/multiplexer 106 is configured to combine the pulsed pump laser beam, the pulsed seed laser beam, and the at least one diode laser beam onto a common optical fiber as a combined signal. For instance, the laser combiner/multiplexer 106 may include (i) a multiplexer configured to multiplex the pulsed pump laser beam and the pulsed seed laser beam to generate a first combined signal and (ii) a pump/signal combiner configured to combine the first combined signal with the at least one diode laser beam to generate a second combined signal.

The combined signal from the laser combiner/multiplexer 106 is provided to an optical amplifier 110. The optical amplifier 110 is configured to amplify the combined signal received from the laser combiner/multiplexer 106 and provide an amplified optical signal 112. The optical amplifier 110 includes a linear amplifier 114 that provides linear amplification of the combined signal in order to generate an amplified combined signal. The optical amplifier 110 also includes a non-linear amplifier 116 that provides non-linear amplification of the amplified combined signal in order to generate the amplified optical signal 112. The non-linear amplifier 116 may use, for example, Raman amplification during its operation. The combination of linear amplification and non-linear amplification within the optical amplifier 110 enables the provision of an amplified optical signal 112, which in some cases may be in the 2.1 μm range.

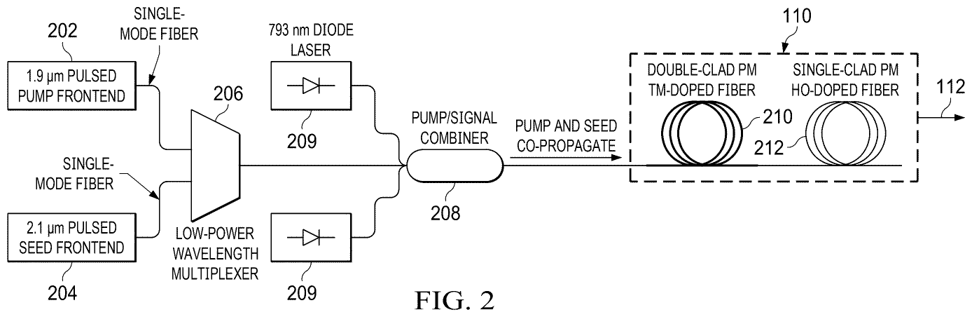

FIG. 2 illustrates a more detailed example of a Raman-boosted pulse-pumped amplifier 200 according to this disclosure. As shown in FIG. 2, a pulsed pump frontend laser 202 is configured to provide a laser beam having a wavelength of approximately 1.9 μm at a first power level, and a pulsed seed frontend laser 204 is configured to provide a laser beam having a wavelength of approximately 2.1 μm at a second power level. The second power level can be less than the first power level. Here, the pulsed pump frontend laser 202 provides the power desired for the amplified optical signal 112. One or more diode lasers 209 are configured to generate one or more diode laser beams. In some embodiments, the one or more diode lasers 209 generate one or more diode laser beams each having a wavelength of approximately 793 nm.

The beams from the pulsed pump frontend laser 202 and the pulsed seed frontend laser 204 are combined together, such as in a core of a single-mode fiber, at a low-power wavelength multiplexer 206 to produce a first combined beam. The first combined beam is output from the multiplexer 206 to a pump/signal combiner 208. The pump/signal combiner 208 is configured to receive and combine the first combined beam from the multiplexer 206 and the diode laser beam(s) from the diode laser(s) 209 in order to generate a second combined beam. The second combined beam can represent the combined beam generated by the laser combiner/multiplexer 106. The combined beam allows the various beams to co-propagate down an optical fiber to the optical amplifier 110.

In this example, the optical amplifier 110 includes a double-clad polarization maintaining (PM) thulium (TM)-doped fiber 210 and a single-clad PM holmium (HO)-doped fiber 212. The TM-doped fiber 210 is configured to perform linear amplification of the combined signal provided from the pump/signal combiner 208. For example, the TM-doped fiber 210 can amplify the 1.9 μm pulsed pump beam within the combined signal using the 793 nm beam(s) from the diode laser(s) 209. In this way, the TM-doped fiber 210 transfers power from the diode laser beam(s) to the 1.9 μm beam of the pulsed pump frontend laser 202. Once the optical signal has been linearly amplified by the TM-doped fiber 210, the resulting amplified combined signal passes to the HO-doped fiber 212. The HO-doped fiber 212 can perform non-linear amplification of the amplified combined signal, possibly including Raman amplification of the amplified combined signal. For instance, the HO-doped fiber 212 can amplify the 2.1 μm pulsed seed beam within the amplified combined signal using the amplified 1.9 μm beam within the amplified combined signal.

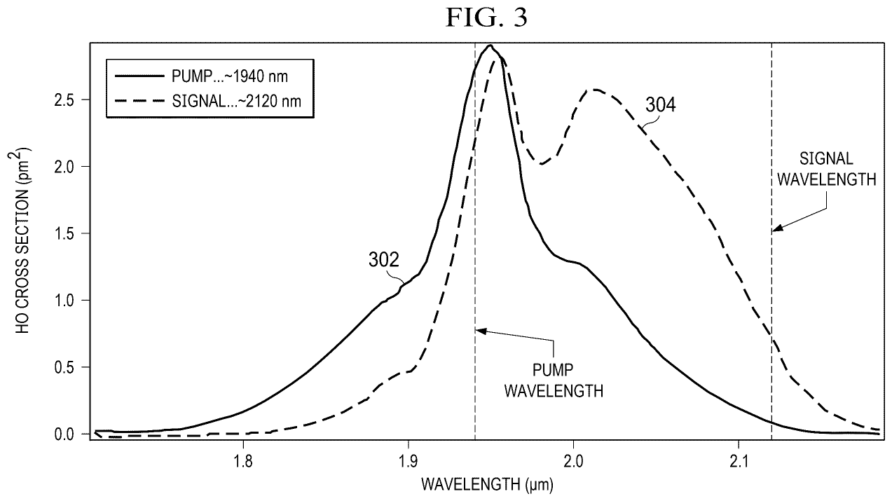

FIG. 3 illustrates wavelengths provided by an example HO-doped fiber 212 according to this disclosure. As can be seen in FIG. 3, a pump signal 302 has a high-power throughput at approximately 1940 nm. Thus, by selecting the wavelength of the pump signal 302 at approximately 1940 nm, a greater amount of power can be throughput to provide an output signal 304 at approximately 2120 nm. An approximately 2120 nm signal can therefore be amplified within the HO-doped fiber 212, which in some cases may be core-pumped at approximately 1940 nm.

In some embodiments, the wavelength of the beam provided by the pulsed pump frontend laser 202 and the wavelength of the beam provided by the pulsed seed frontend laser 204 can be separated by a spectral interval corresponding to the Raman shift within the HO-doped fiber 212. For example, the HO-doped fiber 212 can amplify the signal from 1.9 μm to 2.1 μm responsive to, e.g., based on/using, the power provided by the 1.9 μm signal (which is provided by the TM-doped fiber 210). The amplification occurring within the HO-doped fiber 212 can include Raman amplification, which is a type of non-linear amplification. Here, optical power at the 1.9 μm wavelength within the signal from the TM-doped fiber 210 can provide the power for amplifying the signal at 2.1 μm using Raman amplification. The Raman amplification within the HO-doped fiber 212 can occur when energy from the signal from the TM-doped fiber 210 is imparted to the structure of the optical fiber within the HO-doped fiber 212. When the signal loses energy, the wavelength of photons will increase within the HO-doped fiber 212.

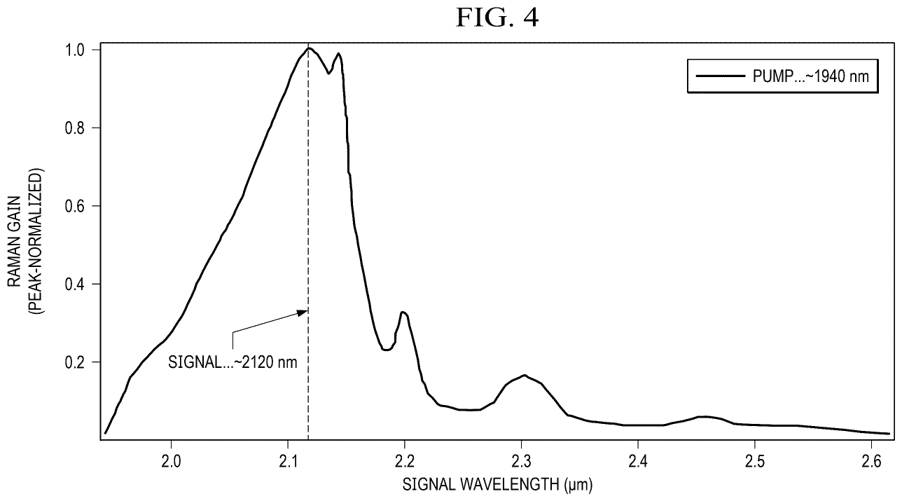

FIG. 4 illustrates a Raman gain at particular wavelengths within an example HO-doped fiber 212 according to this disclosure. As can be seen here, by appropriately selecting the wavelength of the pulsed pump frontend laser 202 and the pulsed seed frontend laser 204, an output signal due to Raman gain from an approximately 1940 nm pump signal may be achieved. Here, when the pump is at approximately 1940 nm, the Raman gain peaks at approximately 2120 nm for the desired signal wavelength.

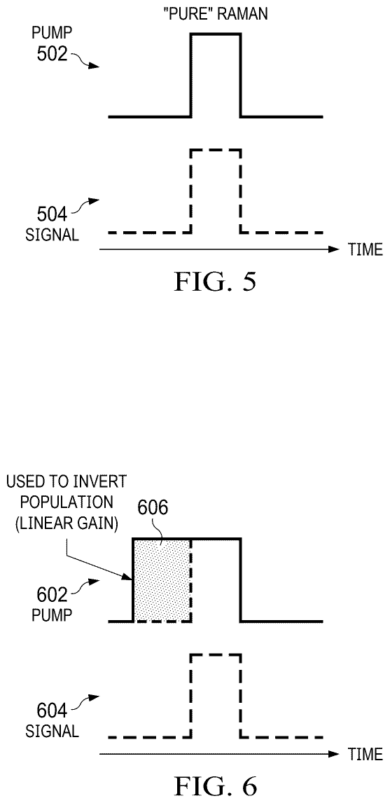

FIG. 5 illustrates a first example approach for time-synchronizing pump pulses and signal pulses within the optical amplifier 110 of FIG. 2 according to this disclosure. More specifically, FIG. 5 illustrates how pure Raman amplification may be improved by overlapping a pulse 502 of the pump signal with a pulse 504 of the seed signal at the optical amplifier 110. Here, the Raman amplification process may occur when the pulse 502 of the pump signal overlaps with the pulse 504 of the seed signal. Thus, as illustrated in FIG. 5, Raman amplification may occur over the entire width of the pulse 504 of the seed signal since the width of the seed signal pulse 504 completely overlaps the width of the pump signal pulse 502.

FIG. 6 illustrates a second example approach for time-synchronizing pump pulses and signal pulses within the optical amplifier 110 of FIG. 2 according to this disclosure. In the implementation of FIG. 6, a pump signal pulse 602 still overlaps a seed signal pulse 604. However, the width of the pump signal pulse 602 is increased to provide a portion 606 that occurs before the rising edge of the seed signal pulse 604. The portion 606 of the pump signal pulse 602 may be used to energize the HO-doped fiber 212 to improve linear gain of the optical amplifier 110. Thus, as illustrated in FIG. 6, Raman amplification may occur over the portion 606 of the pump signal pulse 602 overlapping the width of the seed signal pulse 604. The portion 606 of the pulse 602 that occurs before the pulse 604 can provide linear amplification of the signal.

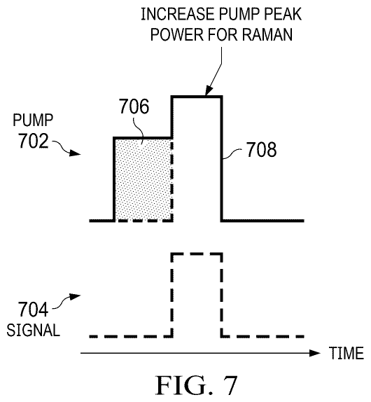

FIG. 7 illustrates a third example approach for time-synchronizing pump pulses and signal pulses within the optical amplifier 110 of FIG. 2 according to this disclosure. In the implementation of FIG. 7, a pump signal pulse 702 still overlaps a seed signal pulse 704. However, the width of the pump signal pulse 702 is increased to provide a portion 706 that occurs before the rising edge of the seed signal pulse 704. The portion 706 of the pump signal pulse 702 is used to energize the HO-doped fiber 212 to improve linear gain of the optical amplifier 110. Additionally, the pulse magnitude of a second portion 708 of the pump signal pulse 702 can be increased to provide a greater degree of Raman gain in the overlapping portion 708 of the pump signal pulse 702 with the seed signal pulse 704. Thus, as illustrated in FIG. 7, greater Raman amplification may occur over the width of the seed signal pulse 704 at an increased magnitude level since the width of the seed signal pulse 704 completely overlaps a portion the width of the increased-magnitude pump signal pulse 702, and the portion 706 of the pulse 702 that occurs before the pulse 704 of the seed signal may provide linear amplification of the signal.

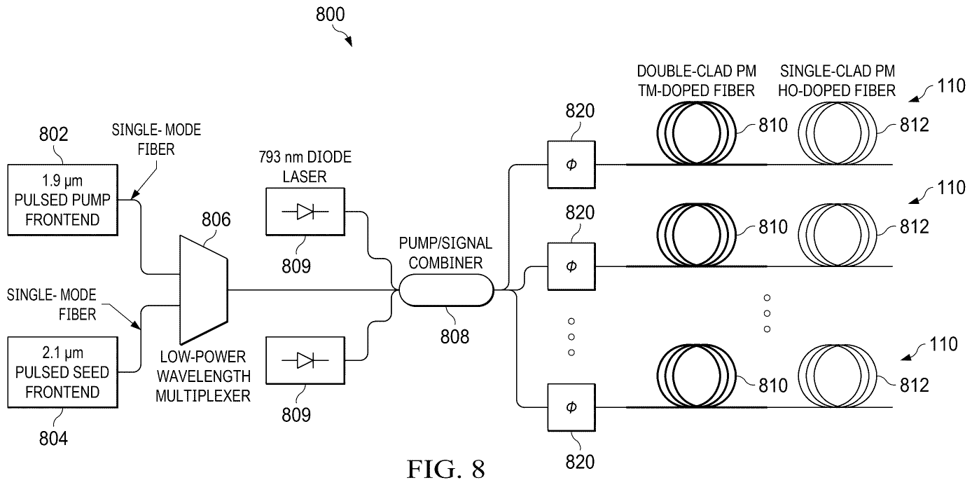

FIG. 8 illustrates another example Raman-boosted pulse-pumped amplifier 800 according to this disclosure. In this example, the amplifier 800 includes multiple channels. Here, the amplifier 800 has a similar overall structure as described with respect to FIG. 2, such as a 1.9 μm pulsed pump frontend laser 802, a 2.1 μm pulsed seed frontend laser 804, a multiplexer 806, a signal combiner 808, and diode lasers 809. In this example, multiple combined signals are provided to multiple optical amplifiers 110, where each optical amplifier 110 is associated with a separate channel 820. Each optical amplifier 110 includes a TM-doped fiber 810 and an HO-doped fiber 812 for respectively performing linear amplification and non-linear/Raman amplification of the corresponding combined signal. The pump signal from the 1.9 μm pulsed pump laser 802 here can be synchronized across the multiple channels 820. Depending on the implementation, the outputs from the optical amplifiers 110 may be combined or output separately for use in any suitable manner.

Although FIGS. 1 through 8 illustrate examples of Raman-boosted pulse-pumped amplifiers and related details, various changes may be made to FIGS. 1 through 8.

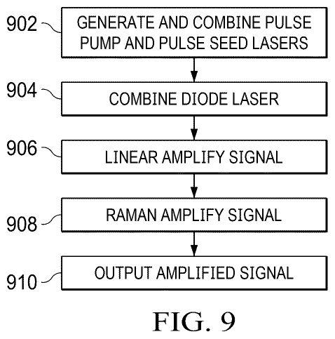

FIG. 9 illustrates an example method 900 for operating a Raman-boosted pulse-pumped amplifier according to this disclosure. For ease of explanation, the method 900 is described as being used in conjunction with the amplifier 200 of FIG. 2. However, the method 900 may be used with any other suitable Raman-boosted pulse-pumped amplifier designed in accordance with this disclosure, such as the amplifier 100 or 800.

As shown in FIG. 9, a pulsed pump laser beam and a pulsed seed laser beam are generated and combined at step 902, such as by using the multiplexer 206. One or more diode laser beams are combined with the resulting beam at step 904, such as by using the pump/signal combiner 208, to provide a combined signal, such as in the core of an optical fiber. The combined signal is linearly amplified at step 906, such as by using the TM-doped fiber 210 of the optical amplifier 110. The amplified combined signal is amplified using Raman or other non-linear amplification at step 908, such as by using the HO-doped fiber 212 of the optical amplifier 110. The linear amplification and non-linear (Raman) amplification both occur within the same fiber. The resulting amplified signal can be output at step 910.

Although FIG. 9 illustrates one example of a method 900 for operating a Raman-boosted pulse-pumped amplifier, various changes may be made to FIG. 9. For example, while shown as a series of steps, various steps in FIG. 9 may overlap, occur in parallel, occur in a different order, or occur any number of times.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A system comprising:
a pulsed pump laser configured to provide a pulsed pump laser beam at a first wavelength and having a first power level associated therewith;
a pulsed seed laser configured to provide a pulsed seed laser beam at a second wavelength and having a second power level associated therewith;
at least one diode laser configured to provide at least one diode laser beam having a third wavelength less than the first wavelength;
an optical combiner configured to combine the pulsed pump laser beam, the pulsed seed laser beam, and the at least one diode laser beam onto a single optical fiber as a combined signal; and
an optical amplifier configured to linearly amplify the combined signal at the first wavelength to generate an amplified combined signal and non-linearly amplify the amplified combined signal at the second wavelength.

2. The system of claim 1, wherein the optical combiner comprises:
a multiplexer configured to multiplex the pulsed pump laser beam and the pulsed seed laser beam to generate a first combined signal; and
a pump/signal combiner configured to combine the first combined signal with the at least one diode laser beam to generate a second combined signal.

3. The system of claim 1, wherein the first amplifier comprises a double-clad thulium-doped fiber configured to amplify the combined signal at the first wavelength responsive to the combined signal at the third wavelength.

4. The system of claim 1, wherein the second amplifier comprises a single-clad holmium-doped fiber configured to amplify the amplified combined signal at the second wavelength responsive to the amplified combined signal at the first wavelength and to provide Raman amplification.

5. The system of claim 1, wherein:
the first wavelength is approximately 1.9 μm;
the second wavelength is approximately 2.1 μm; and
the third wavelength is approximately 793 nm.

6. The system of claim 1, wherein a first pulse width of the pulsed pump laser beam is configured to overlap an entire second pulse width of the pulsed seed laser beam to provide non-linear amplification in the second amplifier.

7. The system of claim 1, wherein a first pulse width of the pulsed pump laser beam is configured to be wider than a second pulse width of the pulsed seed laser beam such that a portion of the first pulse width exceeds the second pulse width to increase linear amplification within the first amplifier.

8. The system of claim 1, wherein a magnitude of at least a portion of a first pulse width of the pulsed pump laser beam is increased to increase non-linear application within the second amplifier.

9. The system of claim 1, wherein the first and second wavelengths are separated by a spectral interval corresponding to a Raman shift within the second amplifier.

10. The system of claim 1,
wherein the second wavelength greater than the first wavelength, the second power level less than the first power level; and
wherein the optical amplifier comprises:
a first amplifier configured to linearly amplify the combined signal at the first wavelength based on the combined signal at the third wavelength; and
a second amplifier configured to non-linearly amplify the amplified combined signal at the second wavelength based on the amplified combined signal at the first wavelength.

11. A method comprising:
generating a pulsed pump laser beam at a first wavelength and having a first power level associated therewith using a pulsed pump laser;
generating a pulsed seed laser beam at a second wavelength and having a second power level associated therewith using a pulsed seed laser;
generating at least one diode laser beam each having a third wavelength less than the first wavelength using at least one diode laser;
combining the pulsed pump laser beam, the pulsed seed laser beam, and the at least one diode laser beam onto a single optical fiber as a combined signal using an optical combiner; and
linearly amplifying the combined signal at the first wavelength to generate an amplified combined signal and non-linearly amplify the amplified combined signal at the second wavelength using an optical amplifier.

12. The method of claim 11, wherein the optical combiner comprises:
a multiplexer that multiplexes the pulsed pump laser beam and the pulsed seed laser beam to generate a first combined signal; and
a pump/signal combiner that combines the first combined signal with the at least one diode laser beam to generate a second combined signal.

13. The method of claim 11, wherein the first amplifier comprises a double-clad thulium-doped fiber that amplifies the combined signal at the first wavelength responsive to the combined signal at the third wavelength.

14. The method of claim 11, wherein the second amplifier comprises a single-clad holmium-doped fiber that amplifies the amplified combined signal at the second wavelength responsive to the amplified combined signal at the first wavelength and that provides Raman amplification.

15. The method of claim 11, wherein:
the first wavelength is approximately 1.9 μm;
the second wavelength is approximately 2.1 μm; and
the third wavelength is approximately 793 nm.

16. The method of claim 11, wherein a first pulse width of the pulsed pump laser beam overlaps an entire second pulse width of the pulsed seed laser beam to provide non-linear amplification in the second amplifier.

17. The method of claim 11, wherein a first pulse width of the pulsed pump laser beam is wider than a second pulse width of the pulsed seed laser beam such that a portion of the first pulse width exceeds the second pulse width to increase linear amplification within the first amplifier.

18. The method of claim 11, wherein a magnitude of at least a portion of a first pulse width of the pulsed pump laser beam is increased to increase non-linear application within the second amplifier.

19. The method of claim 11, wherein the first and second wavelengths are separated by a spectral interval corresponding to a Raman shift within the second amplifier.

20. A system comprising:
a pulsed pump laser configured to provide a pulsed pump laser beam at an approximately 1.9 μm wavelength and having a first power level associated therewith;
a pulsed seed laser configured to provide a pulsed seed laser beam at an approximately 2.1 μm wavelength and having a second power level associated therewith, the second power level less than the first power level;
at least one diode laser configured to provide at least one diode laser beam each having an approximately 793 nm wavelength;
an optical combiner configured to combine the pulsed pump laser beam, the pulsed seed laser beam, and the at least one diode laser beam onto a single optical fiber as a combined signal; and
an optical amplifier configured to receive the combined signal, the optical amplifier comprising:
a double-clad thulium-doped fiber configured to linearly amplify the combined signal at the approximately 1.9 μm wavelength responsive to the combined signal at the approximately 793 nm wavelength in order to generate an amplified combined signal; and
a single-clad holmium-doped fiber configured to non-linearly amplify the amplified combined signal at the approximately 2.1 μm wavelength responsive to the amplified combined signal at the approximately 1.9 μm wavelength and provide Raman amplification.
